(19) United States
(12) Patent Application Publication
(10) Pub. No.: US 2008/0030039 A1
(43) Pub. Date: Feb. 7, 2008

(54) VEHICLE SEAT BACK APPENDAGE

(75) Inventors: Alan Sturt, West Bloomfield, MI (US); George B. Byma, Clarkston, MI (US); Paul Rye, Brighton, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/461,494

(22) Filed: Aug. 1, 2006

(51) Int. Cl. B60N 2/00

(52) U.S. Cl. 296/63

(57) ABSTRACT

A planar member connected to, and disposed behind, a vehicle seat assembly having a seat back and seat bottom, the planar member moveable between a first position adjacent the seat back and a second position adjacent a floor of a vehicle. The planar member has an upper and lower section connected to each other. The upper section is moveable between a first position and a second position. The upper section is adjacent the seat back when the planar member and upper section are in their respective first positions. The upper section forms a shelf when the planar member is in the first position and the upper section is in the second position. The upper section is perpendicular to, and forms a compartment within a cavity in the floor of the vehicle when the planar member and the upper section are in their respective second positions.

### BACKGROUND OF THE INVENTION

1. Field of the Invention

This invention relates to vehicle seat back appendages.

2. Background Art

The following U.S. patents relate to automotive seat back appendages: U.S. Pat. No. 6,547,298; U.S. Pat. No. 6,598,926; and U.S. Pat. No. 6,918,160.

### SUMMARY OF THE INVENTION

In accordance with one aspect of the invention, a vehicle seat system is provided. In a first embodiment, the vehicle seat system includes a seat assembly that can be attached to a floor of a vehicle. The seat assembly may have a seat bottom and a seat back. The first embodiment also includes a substantially planar member that can be connected to the seat assembly and disposed rearward thereof. The planar member can be configured for movement between a first position that is substantially adjacent and substantially parallel to a back portion of the seat back, and in a second position that is substantially adjacent and substantially parallel to the floor of the vehicle. The planar member can have an upper section and a lower section that is connected to the upper section. The upper section can be configured for movement between a first position and a second position with respect to the lower section. When the substantially planar member is in the first position, and the upper section is in the first position, the upper section can be substantially adjacent and substantially parallel to the back portion of the seat back. When the substantially planar member is in the first position and the upper section is in the second position the upper section can be substantially parallel to the floor of the vehicle.

In some implementations of this first embodiment, the substantially planar member is rotatably connected to the seat assembly. Further, the planar member may be rotatably connected in the proximity of the bottom portion of the seat assembly. Additionally, the lower section may be rotatably connected to the upper section.

In other implementations of the first embodiment, the vehicle seat system also includes a first hinge and a second hinge. In these implementations, the lower section can be connected to the upper section by the first hinge, and the substantially planar member can be connected to the seat assembly by the second hinge.

In other implementations of the first embodiment, the first hinge has an angle limiter that holds the upper section in the second position.

In other implementations of the vehicle seat system, in vehicles where the floor of the vehicle has a cavity rearward of the seat assembly to receive the folded seat assembly or store cargo, the substantially planar member can at least partially cover the cavity when the substantially planar member is in the second position and the upper section is in the first position. In further implementations, when the substantially planar member is in the second position, and the upper section is in the second position, a portion of the cavity may be uncovered. In further implementations, when the substantially planar member is in the second position, and the upper section is in the second position, the upper section may be disposed within the cavity of the vehicle so that it is substantially perpendicular to a floor of the cavity. In this configuration, the upper section partitions the cavity to form an exposed cargo containment area.

In a second embodiment of the present invention, a seat appendage is provided for use with a vehicle having a seat assembly attached to a floor of the vehicle, the seat assembly having a seat back and a seat bottom, and the floor having a cavity disposed behind the seat assembly. In this second embodiment, the seat appendage includes an upper panel and a lower panel having an upper end and a lower end. The upper panel can be rotatably connected to the lower panel in the proximity of the lower panel's upper end. The lower panel can be rotatably connected to the seat assembly in the proximity of the lower panel's lower end with the lower panel being disposed rearward of the seat assembly. The upper panel can be configured for movement between a first position and a second position with respect to the lower panel. The lower panel can be configured for movement between a first position and a second position with respect to the seat assembly. The upper panel can be substantially adjacent and substantially parallel to the seat back when the upper panel is in the first position and the lower panel is in the first position. The upper panel can be substantially parallel to the floor of the vehicle when the upper panel is in the second position and the lower panel is in the first position.

In other implementations of the second embodiment, the upper panel and lower panel at least partially cover the cavity when the upper panel is in the first position and the lower panel is in the second position. In this implementation, a portion of the cavity can be uncovered when the upper panel is in the second position and the lower panel is in the second position. In a further variation of this implementation, when the upper panel is in the second position and the lower panel is in the second position, the upper panel can be disposed within the cavity in an orientation that is substantially perpendicular to a floor of the cavity. In this configuration, the upper panel partitions the cavity to form an exposed cargo containment area. In a further variation of this implementation, the seat appendage can include a first hinge and a second hinge. The upper panel can be connected to the lower panel by the first hinge and a lower panel can be connected to the seat assembly by the second hinge. In still a further variation of this implementation, the first hinge has an angle limiter to hold the upper panel in an orientation that is substantially parallel to the floor when the upper panel is in the second position and the lower panel is in the first position.

In a third embodiment of this invention, an automotive rear seat assembly is provided for use in combination with a vehicle having a rear seat and a floor having a cavity disposed behind the rear seat to receive at least a portion of the rear seat when it is folded. In this third embodiment, the seat assembly includes a seat bottom, a seat back connected to the seat bottom, a substantially planar member having a lower section and an upper section, a first hinge connecting the lower section to the upper section, and a second hinge connecting the lower section to the seat back. In this embodiment, the substantially planar member is disposed rearward of the seat back. The upper section can be configured to rotate about the first hinge between a first position and a second position with respect to the lower section. The lower section can be configured to rotate about the second hinge between a first position and a second position with respect to the rear seat. The upper section can be substantially adjacent and substantially parallel to a back portion of the seat back when the upper section is in the first position and the lower section is in the first position. The upper section can form a shelf that is substantially parallel to the floor of the vehicle when the upper section is in the second position and the lower section is in the first position. The substantially planar member can at least partially cover the cavity when the upper section is in the first position and the lower section is in the second position.

In at least one implementation of this third embodiment, a portion of the cavity can be uncovered and the upper section can be at least partially disposed within the cavity in an orientation that is substantially perpendicular to a floor of the cavity to form a cargo containment area when the upper section is in the second position and the lower section is in the second position.

In a variation of this implementation, the upper section can have a depression to facilitate its use as a shelf. In a further variation of this implementation, the first hinge has an angle limiter to hold the upper section in the second position when the lower section is in the first position. In another implementation of this third embodiment, the vehicle can have a rear hatch which can cooperate with the upper section to cover the cargo area when the rear hatch is closed and the upper section is in the second position and the lower section is in the first position.

### BRIEF DESCRIPTION OF THE DRAWINGS

FIG. 1 is a cutaway side view of a vehicle equipped with a vehicle seat system in accordance with one embodiment of the present invention;

FIG. 2 is a perspective view of a first configuration of the vehicle seat system illustrated in FIG. 1;

FIG. 3 is a perspective view of a second configuration of the vehicle seat system of FIG. 1;

FIG. 4 is a perspective view of a third configuration of the vehicle seat system shown in FIG. 1 in another arrangement;

FIG. 5 is a perspective view of a fourth configuration of the vehicle seat system shown in FIG. 1;

FIG. 6 is a side view of the vehicle seat system of FIG. 1 in another configuration;

FIG. 7 is a side view of the vehicle seat system of FIG. 1 in another configuration.

### DETAILED DESCRIPTION OF THE ILLUSTRATED EMBODIMENT(S)

Reference will now be made in detail to the illustrated embodiments of the present invention which constitute the best mode of the practicing the invention presently known to the inventors. The figures are not necessarily drawn to scale. However, it is to be understood that the disclosed embodiments are merely exemplary of the invention that may be implemented in various and alternative forms. Therefore, specific details disclosed herein are not to be interpreted as limiting, but merely as representative of the various aspects of the invention and/or as a representative basis for teaching one skilled in the art to variously employ the present invention.

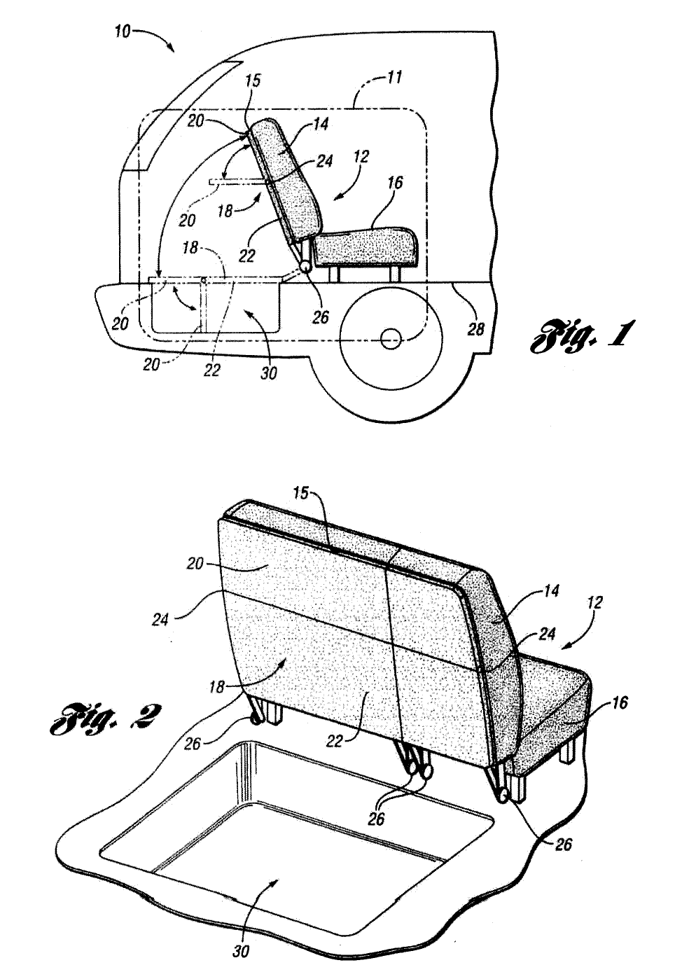

FIG. 1 depicts a vehicle 10 equipped with an embodiment of the vehicle seat system 11 of the present invention. The illustrated embodiment shows the vehicle seat system attached to a split folding rear seat having separate sections which can fold and which can be stowed independently. The illustrated vehicle seat system likewise has separate segments that can operate independently and which correspond to, and which operate in conjunction with, the portion of the rear seat to which it is attached. In vehicles having a single segment rear seat (i.e., non-split folding rear seat), the vehicle seat system would likewise have only a single segment.

In the illustrated embodiment, the vehicle seat system includes an automotive seat assembly 12 having a seat back 14 and a seat bottom 16 and a seat appendage 13 (see FIG. 3). In this embodiment, a substantially planar member 18 comprises an upper section 20 and a lower section 22. Upper section 20 is connected to lower section 22 by a first hinge assembly 24. Substantially planar member 18 is connected to the seat assembly 12 by a second hinge assembly 26. As illustrated, the vehicle has a floor 28 having a cavity 30 disposed behind seat assembly 12.

In this embodiment, the planar member 18 is configured to move between an upright position and a lowered position. Planar member 18 can be moved between the upright position and the lowered position by rotating it about its connection with the seat assembly. As shown in FIG. 1, in the upright position, the planar member 18 is positioned immediately behind and adjacent to a back portion 15 of the seat back 14. In the illustrated embodiment, the planar member 18 is held in the upright position by hinge assembly 24. In other embodiments, the planar member 18 may be held in the upright position adjacent to the seat back 14 by means of a latch or a tether or any other means effective for holding planar member 18 upright and adjacent to seat back 14.

Hinge assembly 24 and hinge assembly 26 allow planar member 18 to be configured in at least four configurations. These four configurations are illustrated in FIG. 1. The upright configuration for planar member 18, as discussed above, is shown in FIG. 1 in solid lines. The three additional configurations for planar member 18 are illustrated in phantom lines and will be discussed in greater detail below.

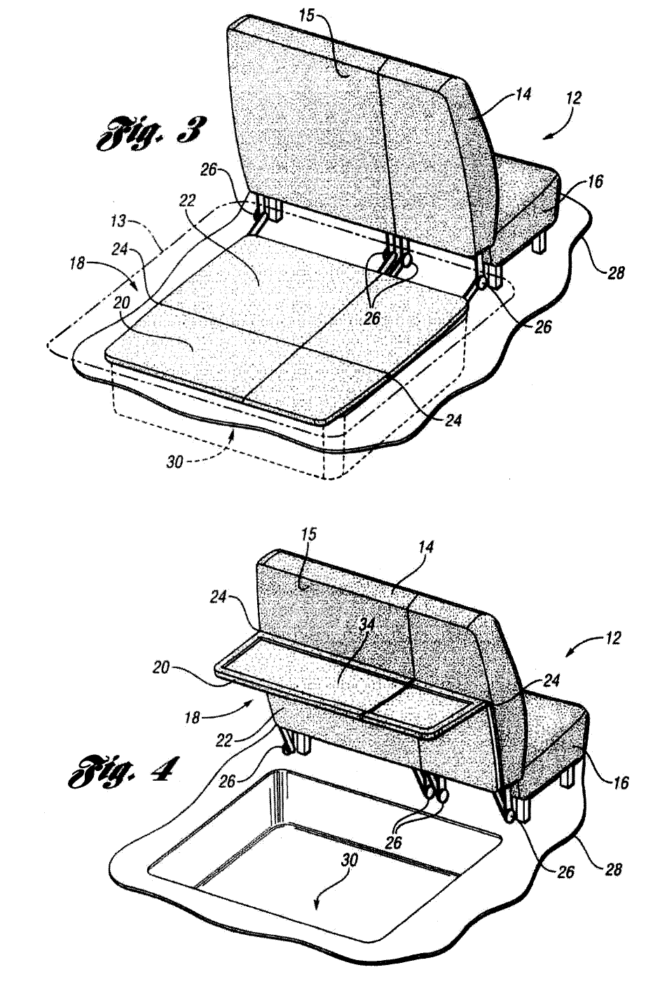

FIG. 2 illustrates the vehicle seat system in a first configuration. In this illustration, planar member 18 is depicted in the upright position. In this position, upper section 20 and lower section 22 are aligned with each other. In this embodiment, upper section 20 is held in position aligned with lower section 22 and adjacent to seat back 14 by the first hinge assembly 24 having an angle limiter. In alternative embodiments, upper section 20 may be secured by a tether, a latch, or any other means effective to secure upper section 20. In this configuration, cavity 30 is uncovered, allowing a user to view the cavity and to have access to it.

In FIG. 3, a second configuration of the vehicle seat system is illustrated. Planar member 18 has been moved to a lowered position to cover cavity 30. In this configuration, upper section 20 remains in alignment with lower section 22. In this configuration, any items placed in cavity 30 are neither visible nor directly accessible. In this embodiment, planar member 18 is disposed outside cavity 30 and thus is disposed above the floor 28. In other embodiments, a lip or other accommodation may be provided around the perimeter of cavity 30 to receive planar member 18 such that, when planar member 18 covers the cavity, it lies substantially flush with floor 28.

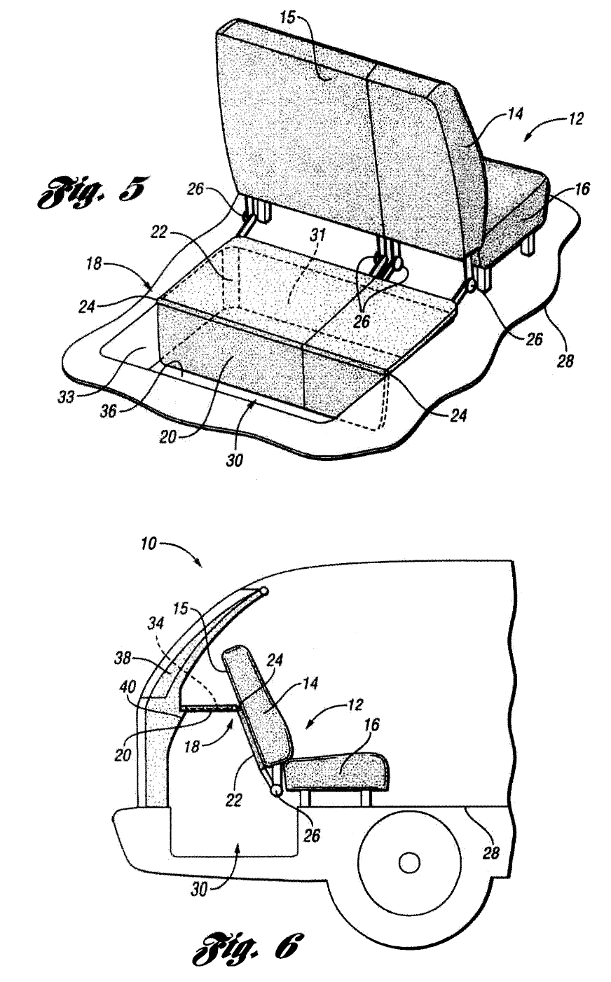

FIG. 4 illustrates a third configuration of the vehicle seat system. In this configuration, upper section 20 has been rotated about the first hinge assembly 24 to a lowered position that is substantially parallel to the floor 28. In this configuration lower section 22 remains upright, substantially parallel and substantially adjacent to the seat back 14. In the embodiment illustrated in FIG. 4, upper section 20 is held parallel to the floor 28 by a hinge assembly 24 having an angle limiter. In other embodiments, upper section 20 may be held in position substantially parallel to floor 28 by a latch, by support struts, by a tether, or by any other means effective to secure upper section 20 in a manner substantially parallel to the floor 28. In this configuration, upper section 20 may serve as a shelf that a user may use to store cargo, serve food, use as a baby changing station, or for any other purpose served by shelves. As depicted in FIG. 4, upper section 20 may have a depression 34 to facilitate its use as a shelf.

FIG. 5 depicts a fourth configuration for the vehicle seat system. In this configuration, both planar member 18 and upper section 20 are in their respective lowered positions. In this configuration, cavity 30 is divided by lower section 22 into a partially covered portion 31 and a partially exposed portion 33. As illustrated, upper section 20 is disposed within cavity 30 and positioned in a substantially perpendicular orientation to the cavity floor 36. As illustrated, upper section 20 serves as the back wall of the uncovered portion 31 of cavity 30. This configuration facilitates the carrying of smaller items such as shopping bags that may otherwise topple or tumble if the cavity 30 were not partitioned. Depending on the construction of planar member 18 and the upper section 20, and the size and construction of the cavity 30, a user desiring to reconfigure the vehicle seat system from the second configuration to the fourth configuration may have to briefly lift planar member 18 out of its lowered position to permit rotation of upper section 20 into its lowered position.

In other embodiments of the vehicle seat system, upper section 20 can rotate about the first hinge assembly 24 in a direction away from its lowered position to uncover a portion of cavity 30 thus giving a user access to the entire cavity 30 while leaving at least a portion of it covered. In other embodiments, the first hinge 24 may be able to hold the upper section in various positions as upper section 20 rotates about the first hinge 24. In some embodiments, upper section 20 may be rotated about the first hinge 24 until it comes to rest on top of lower section 22.

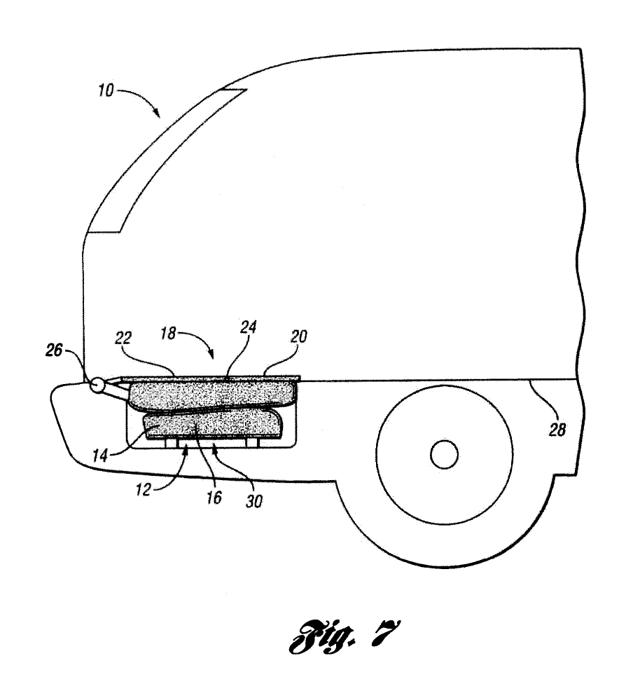

FIG. 6 depicts an embodiment of the vehicle seat system used in combination with a vehicle having a rear hatch 38. In this embodiment, when the planar member 18 is in the upright position and upper section 20 is in the lower position, upper section 20 cooperates with hatch 38 and acts as a cargo area cover. In the illustrated embodiment, hatch 38 has a protrusion 40 which receives the upper section 20 and prevents the upper section 20 from rotating about the first hinge assembly 24 towards its lowered position. In other embodiments, upper section 20 may cooperate with other internal components of the vehicle 10 to maintain a position substantially parallel to the floor 28. In still other embodiments, a tether or a hinge having an angle limiter can be used to hold the upper section 20 in an orientation that is substantially parallel to the floor 28 and substantially adjacent to hatch 38 when hatch 38 is closed.

FIG. 7 depicts the vehicle seat system in a configuration covering the cavity 30 and vehicle seat assembly 12 when vehicle seat assembly 12 is in a folded configuration and stored in cavity 30. As illustrated in FIG. 7, planar member 18 protrudes above floor 28. In other configurations, cavity 30 may have a lip around its perimeter to receive planar member 18, or other adaptations may be employed to permit planar member 18 to be at least partially received within cavity 30 so that planar member 18 is substantially flush with the floor 28 when the seat assembly 12 is stored in the cavity 30.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle seat system comprising:
a vehicle having a floor;
a seat assembly attachable to the floor of the vehicle, the seat assembly having a seat bottom and a seat back; and
a substantially planar member connected to the seat assembly and disposed rearward thereof, the planar member being configured for movement between a first position that is substantially adjacent and substantially parallel to a back portion of the seat back and a second position that is substantially adjacent and substantially parallel to the floor of the vehicle, the planar member having an upper section and a lower section connected to the upper section, the upper section being configured for movement between a first position and a second position with respect to the lower section, the upper section being substantially adjacent and substantially parallel to the back portion of the seat back when the substantially planar member is in the first position and the upper section is in the first position, and the upper section being substantially parallel to the floor of the vehicle when the substantially planar member is in the first position and the upper section is in the second position.

2. The vehicle seat system of claim 1 wherein the substantially planar member is rotatably connected to the seat assembly.

3. The vehicle seat system of claim 2 wherein the substantially planar member is rotatably connected proximate a bottom portion of the seat assembly.

4. The vehicle seat system of claim 3 wherein the lower section is rotatably connected to the upper section.

5. The vehicle seat system of claim 4 further comprising a first hinge and a second hinge, the lower section being connected to the upper section by the first hinge and the substantially planar member being connected to the seat assembly by the second hinge.

6. The vehicle seat system of claim 5 wherein the first hinge has an angle limiter to hold the upper section in the second position when the substantially planar member is in the first position.

7. The vehicle seat system of claim 1, wherein the floor of the vehicle has a cavity rearward of the seat assembly, and the substantially planar member at least partially covers the cavity when the planar member is in the second position and the upper section is in the first position.

8. The vehicle seat system of claim 7 wherein, when the substantially planar member is in the second position and the upper section is in the second position, a portion of the cavity is uncovered.

9. The vehicle seat system of claim 8 wherein, when the substantially planar member is in the second position and the upper section is in the second position, the upper section is at least partially disposed within the cavity substantially perpendicularly to a floor of the cavity to form a cargo containment area.

10. A seat appendage for use with a vehicle having a floor and a seat assembly, the seat assembly being attached to the floor, the seat assembly having a seat back and a seat bottom, the floor having a cavity therein disposed behind the seat assembly, the seat appendage comprising:
an upper panel; and
a lower panel having an upper end and a lower end, the upper panel being rotatably connected to the lower panel proximate the upper end and, the lower panel being rotatably connectable to the seat assembly proximate the lower end and disposed rearward of the seat assembly, the upper panel being configured for movement between a first position and a second position with respect to the lower panel, the lower panel being configured for movement between a first position and a second position with respect to the seat assembly, the upper panel being substantially adjacent and substantially parallel to the seat back when the upper panel is in the first position and the lower panel is in the first position, and the upper panel being substantially parallel to the floor of the vehicle when the upper panel is in the second position and the lower panel is in the first position.

11. The seat appendage of claim 10 wherein the upper panel and the lower panel at least partially cover the cavity when the upper panel is in the first position and the lower panel is in the second position.

12. The seat appendage of claim 11 wherein a portion of the cavity is uncovered when the upper panel is in the second position and the lower panel is in the second position.

13. The seat appendage of claim 12 wherein, when the upper panel is in the second position and the lower panel is in the second position, the upper panel is at least partially disposed within the cavity substantially perpendicularly to a floor of the cavity to form a cargo containment area.

14. The seat appendage of claim 13 further comprising a first hinge and a second hinge, and wherein the upper panel is connected to the lower panel by the first hinge and the lower panel is connectable to the seat assembly by the second hinge.

15. The seat appendage of claim 14 the first hinge has an angle limiter that holds the upper panel substantially parallel to the floor when the upper panel is in the second position and the lower panel is in the first position.

16. An automotive rear seat assembly for use with a vehicle having a rear seat and a floor having a cavity disposed rearward of the rear seat to receive at least a portion of the rear seat when folded, the automotive rear seat assembly comprising:
a seat bottom;
a seat back connected to the seat bottom;
a substantially planar member having a lower section and an upper section, and disposed rearward of the seat back,
a first hinge connecting the lower section to the upper section; and
a second hinge connecting the lower section to the seat back or the seat bottom,
the upper section being configured to rotate about the first hinge between a first position and a second position with respect to the lower section, the lower section being configured to rotate about the second hinge between a first position and a second position with respect to the seat back, the upper section being substantially adjacent and substantially parallel to a back portion of the seat back when the upper section is in the first position and the lower section is in the first position, the upper section forming a shelf that is substantially parallel to the floor of the vehicle when the upper section is in the second position and the lower section is in the first position, and the substantially planar member at least partially covering the cavity when the upper section is in the first position and the lower section is in the second position.

17. The automotive rear seat assembly of claim 16 wherein a portion of the cavity is uncovered and the upper section is at least partially disposed within the cavity substantially perpendicularly to a floor of the cavity to form a cargo containment area when the upper section is in the second position and the lower section is in the second position.

18. The automotive seat assembly of claim 17 wherein the upper section has a depression therein to facilitate its use as a shelf.

19. The automotive seat assembly of claim 18 the first hinge has an angle limiter that holds the upper section in the second position when the lower section is in the first position.

20. The automotive seat assembly of claim 18, the vehicle further having a rear hatch, wherein the upper section cooperates with the hatch to cover the cargo area when the rear hatch is closed and the upper section is in the second position and the lower section is in the first position.
